(19) United States
(12) Patent Application Publication
(10) Pub. No.: US 2014/0267048 A1
(43) Pub. Date: Sep. 18, 2014

(54) Home Row Key Strip for Touch Screens

(71) Applicant: Charles Albert Morris, Maquoketa, IA (US)

(72) Inventor: Charles Albert Morris, Maquoketa, IA (US)

(21) Appl. No.: 13/839,435

(22) Filed: Mar. 15, 2013

(51) Int. Cl. G06F 3/02; G06F 3/041

(52) U.S. Cl. CPC G06F 3/0219; G06F 3/041
USPC 345/168

(57) ABSTRACT

A movable semi-rigid strip of depressible keys that overlays a touch screen in order to provide tactile home positions for the fingers. The home row key strip can be easily moved into place over the visual image of the home row when the touch screen's keyboard appears. Anti-slip material on the bottom surface of the key strip keeps it in place at the typist types. An alternate configuration provides tabs on the end of the key strip that create tension on the sides of the touch screen or tablet computer in order to keep the key strip in place over the home row, but allowing the strip to slide quickly to a border region. Other configurations for affixing the key strip include magnets, tracks on the sides of the touch screen, and hinged arms that allow the key strip to move quickly on and off the touch screen.

I claim the benefit of the provisional application No. 61/612,263.

### BACKGROUND OF THE INVENTION

Current U.S. Classes: 715/773, 400/491.3, 400/479.1, 400/489, 345/173, 345/168, 341/33

The present invention relates to a virtual keyboard on a touch screen and means for providing tactile feedback on demand with minimal intrusion upon the overall touch screen experience. In particular, the present invention relates to a semi-rigid overlay with depressible keys for a home row of a keyboard on a touch screen, configured in such a way that the overlay can be easily moved to a border region of the touch screen.

Numerous embodiments of tactile overlays for touch screen keyboards exist in the prior art, including U.S. Patent Application #2010/0328251 A1, U.S. Patent Application #2010/0302168 A1, U.S. Pat. No. 8,243,038, U.S. Pat. No. 7,659,885, U.S. Pat. No. 6,880,998, U.S. Pat. No. 5,572,573, U.S. Pat. No. 4,931,782, and U.S. Pat. No. 4,423,299.

U.S. Pat. No. 6,667,738 offers a flexible overlay for touch screen keyboards that retracts into a cavity within the housing of a touch screen. This solution allows the overlay to be transported with the touch screen, but it requires a bulkier housing for the touch screen in order to allow for the cavity.

In U.S. Pat. No. 8,206,047, a flexible elastomeric home row overlay for touch screen keyboards is presented with specialized key structures peculiar to the thin elastomeric material employed. The flexibility of this overlay prevents its practicable use as a strictly home row key strip, because a narrow home row strip of elastomeric material would be too easily distorted away from the home row by fingers typing rapidly, and the company producing overlays based on U.S. Pat. No. 8,206,047, TouchFire, Inc., has opted instead to manufacture and sell full keyboard overlays. The TouchFire, Inc. overlay must be fully removed from the touch screen and set aside in order to return to normal, non-typing use of the touch screen.

My U.S. Pat. No. 6,869,289 introduced the concept of a tactile, depressible home row in an otherwise touch-sensitive keyboard. The current patent application applies that principle to touch screens and uniquely addresses the need for tactile points of reference while offering the most minimal intrusion into the overall touch screen experience.

It would be advantageous to provide a compact semi-rigid strip with depressible home keys for touch screen keyboards. The key strip of the present invention will provide tactile points of reference that will enable the typist to type without having to keep his or her hands hovering above the touch screen, and it will move easily and quickly into position for use with the onscreen keyboard and out of position to a border region when not in use.

### BRIEF SUMMARY OF THE INVENTION

It is an object of the invention to provide a semi-rigid overlay strip of eight depressible keys to be placed on a tablet touch screen across the home row of the touch screen's graphical keyboard providing eight home keys for the eight fingers of the typist.

It is a further object of the invention to provide modified form of construction in which the semi-rigid overlay strip consists of eight depressible keys to be placed on a multi-touch computerized display surface's touch screen across the home row of the touch screen's graphical keyboard providing eight home keys for the eight fingers of the typist.

It is a further object of the invention to provide a modified form of construction in which the semi-rigid overlay strip consists of four depressible keys to be placed on a cell phone touch screen across the home row of the touch screen's graphical keyboard providing four home keys for the four fingers of one hand of the typist.

It is a further object of the invention to provide a modified form of construction in which the semi-rigid overlay strip consists of two depressible keys to be placed on a cell phone touch screen across the home row of the touch screen's graphical keyboard providing two home keys for the two thumbs of the typist.

It is a further object of the invention to provide a modified form of construction in which the semi-rigid overlay strip has anti-slip material on its bottom surface in order to keep the overlay strip in place over the touch screen's graphical keyboard's home row.

It is a further object of the invention to provide a modified form of construction in which the semi-rigid overlay strip has flexible tabs on its ends that can be pushed down to go around the sides and under the bottom of a housing for the touch screen in order to create tension on the sides and bottom of the housing for the touch screen in order to keep the overlay strip in place over the touch screen's graphical keyboard's home row. Pushing the flexible tabs down to go around the sides and under the bottom of the housing for the touch screen causes the ends of the overlay strip to bend upwards. The user of the overlay strip can then pull the bent ends of the overlay strip toward the center of the touch screen in order to release the tension between the flexible tabs and the touch screen, so the user can easily move the overlay strip back and forth from its place over the home row to a non-touch-sensitive portion of the touch screen.

It is a further object of the invention to provide a modified form of construction in which the semi-rigid overlay strip has suction cups on its ends that adhere to the touch screen in order to keep the overlay strip in place over the home row and in place on a non-touch-sensitive portion of the touch screen.

It is a further object of the invention to provide a modified form of construction in which the semi-rigid overlay strip has magnets on its ends that are attracted to magnets built into the housing body of the touch screen in order to keep the overlay strip in place over the home row and in place on a non-touch-sensitive portion of the touch screen.

It is a further object of the invention to provide a modified form of construction in which the semi-rigid overlay strip has appendages at both ends that ride in a track built into the side of the body for the touch screen.

It is a further object of the invention to provide a modified form of construction in which the semi-rigid overlay strip has appendages at both ends that ride in a track built into a case for the touch screen.

It is a further object of the invention to provide a modified form of construction in which the semi-rigid overlay strip has rigid ends that wrap around the sides and bottom of a housing for the touch screen.

It is a further object of the invention to provide a modified form of construction in which the semi-rigid overlay strip is kept in place on a touch screen by way of hinged arms attached to a case for the touch screen.

It is a further object of the invention to provide a modified form of construction in which the semi-rigid overlay strip is kept in place on a touch screen by way of hinged arms attached to a body for the touch screen.

### BRIEF DESCRIPTION OF THE SEVERAL VIEWS OF THE DRAWING

The present invention will be more fully understood by reference to the following detailed descriptions thereof when read in conjunction with the attached drawings, and wherein:

FIG. 1 is a perspective view of a preferred embodiment of the overlay strip in accordance with the present invention in which there are eight depressible home keys and the semi-rigid overlay strip is kept in place on a tablet computer's touch screen by way of flexible tabs protruding from the ends of the overlay strip; and

FIG. 2 is a perspective view of a modified form of construction of the overlay strip in accordance with the present invention in which there are eight depressible home keys and the semi-rigid overlay strip is kept in place on a tablet computer's touch screen by way of magnets built into the overlay strip and in the tablet computer; and

FIG. 3 is a perspective view of a further modified form of construction of the semi-rigid overlay strip in accordance with the present invention in which there are eight depressible home keys and the overlay strip kept is in place on a multi-touch computerized display surface's touch screen by way of suction cups; and

FIG. 4 is a perspective view of an even further modified form of construction of the semi-rigid overlay strip in accordance with the present invention in which there are eight depressible home keys and the overlay strip is kept in place on a tablet computer's touch screen by way of rigid ends that wrap around the side of the tablet computer; and

FIG. 5 is a perspective view of a still further modified form of construction of the semi-rigid overlay strip in accordance with the present invention in which there are eight depressible home keys and the overlay strip is kept in place on a tablet computer's touch screen by way of protrusions that ride in tracks built into a case for the tablet computer; and

FIG. 6 is a perspective view of a yet still further modified form of construction of the semi-rigid overlay strip in accordance with the present invention in which there are eight depressible home keys and the overlay strip is kept in place on a tablet computer's touch screen by way of flexible hinges and magnets built into to a case for the tablet computer; and

FIG. 7 is a perspective view of a yet further modified form of construction of the semi-rigid overlay strip in accordance with the present invention in which there are four depressible home keys and the overlay strip is kept in place on a cell phone's touch screen by way of hinges attached to a case for the cell phone; and

FIG. 8 is a perspective view of an even yet further modified form of construction of the semi-rigid overlay strip in accordance with the present invention in which there are two depressible home keys and the overlay strip is kept in place on a cell phone's touch screen by way of protrusions that ride in tracks built into the cell phone.

### DETAILED DESCRIPTION OF THE INVENTION

In FIG. 1, there is shown a perspective view of an example of the semi-rigid overlay strip 1 in accordance with the present invention in which there are eight depressible home keys 2-9 and the overlay strip 1 is kept in place over the graphical keyboard 10 of a touch screen 11 of a tablet computer 12 by way of flexible tabs 13 and 14 protruding from the ends of the overlay strip 1.

This overlay strip 1 is particularly useful for providing a compact strip of depressible keys 2-9 for the home row of a touch screen 11 graphical keyboard 10, such that the overlay strip 1 can be easily moved out of the way to a border region 15 of the touch screen 11 or off of the touch screen 11. This overlay strip 1 will provide tactile points of reference that will enable the typist to type without having to keep his or her hands hovering above the touch screen 11.

In FIG. 2 there is shown a perspective view of a further example of the semi-rigid overlay strip 1 in accordance with the present invention in which there are eight depressible home keys 2-9 and the overlay strip 1 is shown out of the typing position in order to show the magnets 18-21 that are built into the tablet computer 12. The overlay strip 1 is kept in place over the graphical keyboard 10 of a touch screen 11 of a tablet computer 12 by way of magnets 16 and 17 built into the overlay strip 1 that are attracted to magnets 18 and 19 that are built into the tablet computer 12, and the overlay strip 1 can be easily moved out of the way to a border region 15 of the touch screen 11 where the overlay strip 1 can be held in place by the attraction of magnets 16 and 17 built into the overlay strip 1 that are attracted to magnets 20 and 21 that are built into the tablet computer 12.

In FIG. 3 there is shown a perspective view of a further example of the semi-rigid overlay strip 1 in accordance with the present invention in which there are eight depressible home keys 2-9 and the overlay strip 1 is kept in place over the graphical keyboard 10 of a touch screen 11 of a multi-touch computerized display surface 22 by way of suction cups 23 and 24.

In FIG. 4 there is shown a perspective view of a further example of the semi-rigid overlay strip 1 in accordance with the present invention in which there are eight depressible home keys 2-9 and the overlay strip 1 is kept in place over the graphical keyboard 10 of a touch screen 11 of a tablet computer 12 by way of rigid ends 25 and 26 that wrap around the side of the tablet computer.

In FIG. 5 there is shown a perspective view of a further example of the semi-rigid overlay strip 1 in accordance with the present invention in which there are eight depressible home keys 2-9 and the overlay strip 1 is kept in place over the graphical keyboard 10 of a touch screen 11 of a tablet computer 12 by way of protrusions 27 and 28 that ride in tracks 29 and 30 built into the tablet computer 12.

In FIG. 6 there is shown a perspective view of a further example of the semi-rigid overlay strip 1 in accordance with the present invention in which there are eight depressible home keys 2-9 and the overlay strip 1 is attached to a case 31 for the tablet computer 12 by way of flexible hinges 32 and 33. The overlay strip 1 is kept in place over the graphical keyboard 10 of a touch screen 11 of a tablet computer 12 by way of magnets 34 and 35 built into the ends of the overlay strip 1 that are attracted to magnets 36 and 37 that are built into the case 31. The overlay strip 1 can be easily moved out of the way to a border region 15 of the touch screen 11 where the overlay strip 1 can be held in place by the attraction of magnets 34 and 35 to magnets 38 and 39 that are built into the case 31.

In FIG. 7 there is shown a perspective view of a further example of the semi-rigid overlay strip 1 in accordance with the present invention in which there are four depressible home keys 40-43 and the overlay strip 1 is kept in place over the graphical keyboard 10 of a touch screen 11 of a cell phone 44 by way of hinges 45 and 46 attached to a case 47 for the cell phone 44. The overlay strip 1 can be easily moved out of the way by way of hinges 45 and 46 to a border region 15 of the touch screen 11.

In FIG. 8 there is shown a perspective view of a further example of the semi-rigid overlay strip 1 in accordance with the present invention in which there are two depressible home keys 48 and 49 and the overlay strip 1 is kept in place over the graphical keyboard 10 of a touch screen 11 of a cell phone 44 by way of protrusions 50 and 51 that ride in tracks 52 and 53 built into the cell phone 44.

I claim:

1. A semi-rigid overlay strip with at least one depressible key to be placed on a touch screen across and on top of a visual image of a home row of an operable keyboard shown on said touch screen, including in combination:
means for moving and securing said overlay strip back and forth between an operable position across and on top of said visual image of a home row for use with said keyboard and an inoperable position across and on top of a non-touch-sensitive margin area of said touch screen, said means for moving and securing said overlay strip consisting of at least one of the following: anti-slip material on a bottom surface of said overlay strip, flexible tabs on the ends of said overlay strip that can be pushed down to go around the sides and under the bottom of a housing for said touch screen in order to create tension on said sides and said bottom, suction cups on said overlay strip's ends, magnets on said overlay strip's ends that are attracted to magnets built into a housing body of said touch screen, appendages on both ends of said overlay strip that ride in a track built into the side of a housing body of said touch screen, appendages at both ends of said overlay strip that ride in a track built into a case for said touch screen, and rigid ends of said overlay strip that wrap around the sides and bottom of a housing body for said touch screen.

2. The combination according to claim 1 wherein said overlay strip consists of eight depressible keys for eight fingers of a typist.

3. The combination according to claim 1 wherein said overlay strip consists of four depressible keys for four fingers of one hand of a typist.

4. The combination according to claim 1 wherein said overlay strip consists of two depressible keys for two thumbs of a typist.

5. The combination according to claim 1 wherein said touch screen is built into a tablet computer.

6. The combination according to claim 1 wherein said touch screen is built into a multi-touch computerized display surface.

7. The combination according to claim 1 wherein said touch screen is built into a smartphone.

8. A semi-rigid overlay strip with at least one depressible home key to be placed on a touch screen across and on top of a visual image of a home row of an operable keyboard shown on said touch screen, including in combination:
a right angle arm extending from each end of said overlay strip;
two hinges, with one hinge connecting each said right angle arm to a housing body of said touch screen, such that said overlay strip can be rotated by way of said two hinges into an operable position across and on top of said visual image of a home row for use with said keyboard, and such that said overlay strip can be rotated by way of said two hinges into an inoperable position away from all touch sensitive areas of said touch screen.

9. The combination according to claim 8 wherein said overlay strip consists of eight depressible keys for eight fingers of a typist.

10. The combination according to claim 8 wherein said overlay strip consists of four depressible keys for four fingers of one hand of a typist.

11. The combination according to claim 8 wherein said overlay strip consists of two depressible keys for two thumbs of a typist.

12. The combination according to claim 8 wherein said touch screen is built into a tablet computer.

13. The combination according to claim 8 wherein said touch screen is built into a multi-touch computerized display surface.

14. The combination according to claim 8 wherein said touch screen is built into a smartphone.

15. A semi-rigid overlay strip with at least one depressible home key to be placed on a touch screen across and on top of a visual image of a home row of an operable keyboard shown on said touch screen, including in combination:
a right angle arm extending from each end of said overlay strip;
two hinges, with one hinge connecting each said right angle arm to a case for a body of said touch screen such that said overlay strip can be rotated by way of said two hinges into an operable position across and on top of said visual image of a home row for use with said keyboard, and such that said overlay strip can be rotated by way of said two hinges into an inoperable position away from all touch sensitive areas of said touch screen.

16. The combination according to claim 15 wherein said overlay strip consists of eight depressible keys for eight fingers of a typist.

17. The combination according to claim 15 wherein said overlay strip consists of four depressible keys for four fingers of one hand of a typist.

18. The combination according to claim 15 wherein said overlay strip consists of two depressible keys for two thumbs of a typist.

19. The combination according to claim 15 wherein said right angle arms extending from each end of said overlay strip are made of a flexible material;
and wherein a magnet is secured to each said right angle arm close to where said right angle arm is connected to said overlay strip;
and wherein magnets are built into said case such that said overlay strip can be kept in said operable position and in said inoperable position.

20. The combination according to claim 15 wherein said right angle arms extending from each end of said overlay strip are made of a flexible material;
and wherein a Velcro piece is secured to each said right angle arm close to where said right angle arm is connected to said overlay strip;
and wherein Velcro pieces are built into said case such that said overlay strip can be kept in said operable position and in said inoperable position.
